(19) United States
(12) Patent Application Publication
(10) Pub. No.: US 2026/0238554 A1
(43) Pub. Date: Aug. 13, 2026

(54) METHODS AND APPARATUS FOR DISTRIBUTING ADAPTIVE ARTIFICIAL INTELLIGENCE MODELS IN A WIRELESS NETWORK

(71) Applicant: InterDigital Patent Holdings, Inc., Wilmington, DE (US)

(72) Inventors: Stephane ONNO, SAINT GREGOIRE (FR); Francois SCHNITZLER, SAINT AVE (FR)

(21) Appl. No.: 19/154,680

(22) PCT Filed: Feb. 8, 2024
(86) PCT No.: PCT/EP2024/053237

§ 371 Date: Aug. 7, 2025

(30) Foreign Application Priority Data
Feb. 10, 2023 (EP) 23305184.6

(51) Int. Cl. H04L 41/16; H04W 52/02

(52) U.S. Cl. CPC H04L 41/16; H04W 52/0235

(57) ABSTRACT

The disclosure pertains to procedures, methods, architectures, apparatus, systems, devices, and computer program products for, and/or directed to distributing adaptive Artificial Intelligence (AI) models in a wireless network. For example, a wireless transmit/receive unit (WTRU) is configured to: transmit, to a network node, information indicating one or more capabilities of the WTRU for running an AI model; receive, from the network node, based on a comparison of the one or more capabilities of the WTRU and a first accuracy level, a first AI model subset of an adaptive AI model, wherein the adaptive AI model comprises a plurality of AI model subsets, each subset being associated with an accuracy level; and run the first AI model subset of the adaptive AI model.

### FIELD

This disclosure pertains to procedures, methods, architectures, apparatus, systems, devices, and computer program products for, and/or directed to distributing adaptive Artificial Intelligence (AI) models in a wireless network.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating several adaptive Al model compositions;

FIG. 3 is a signal flow diagram illustrating signal flow of a WTRU requesting a full model from the wireless network in accordance with a WTRU-centric embodiment;

FIG. 4 is a signal flow diagram illustrating signal flow of a WTRU requesting adaptive loading of a model from the wireless network in accordance with a WTRU-centric embodiment.

FIG. 5 is a signal flow diagram illustrating signal flow for updating an AI model at a WTRU in accordance with a network-centric embodiment; and

FIG. 6 is a flowchart illustrating a representative method for requesting adaptive loading of a model from a wireless network.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### Example Communications System

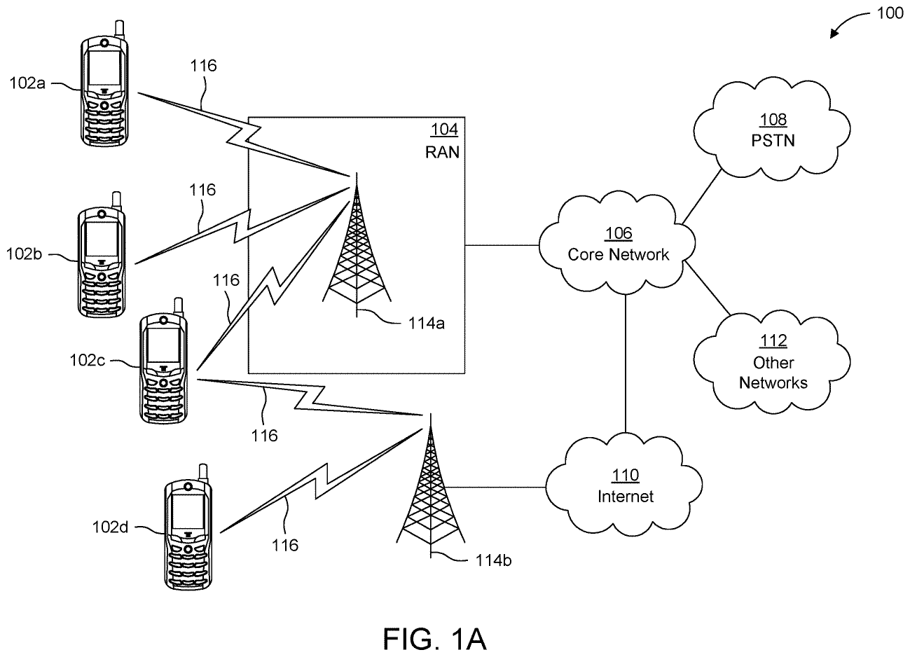

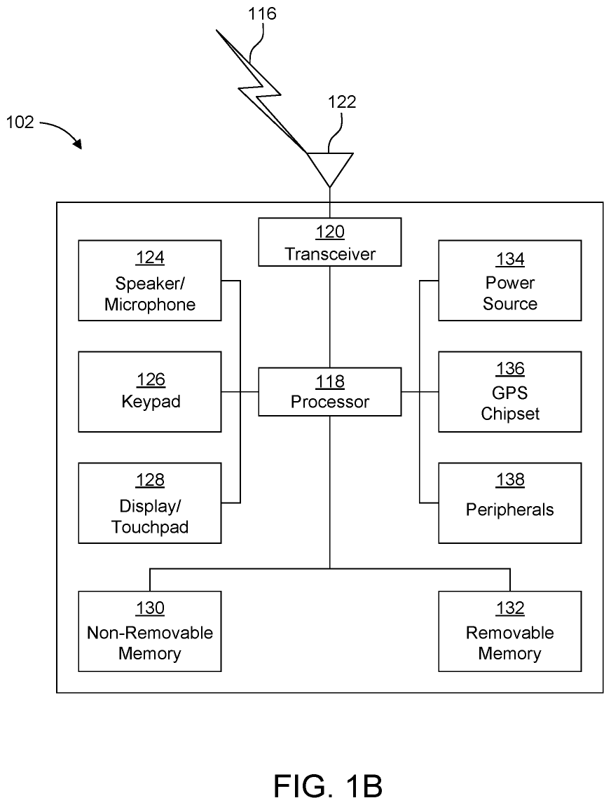

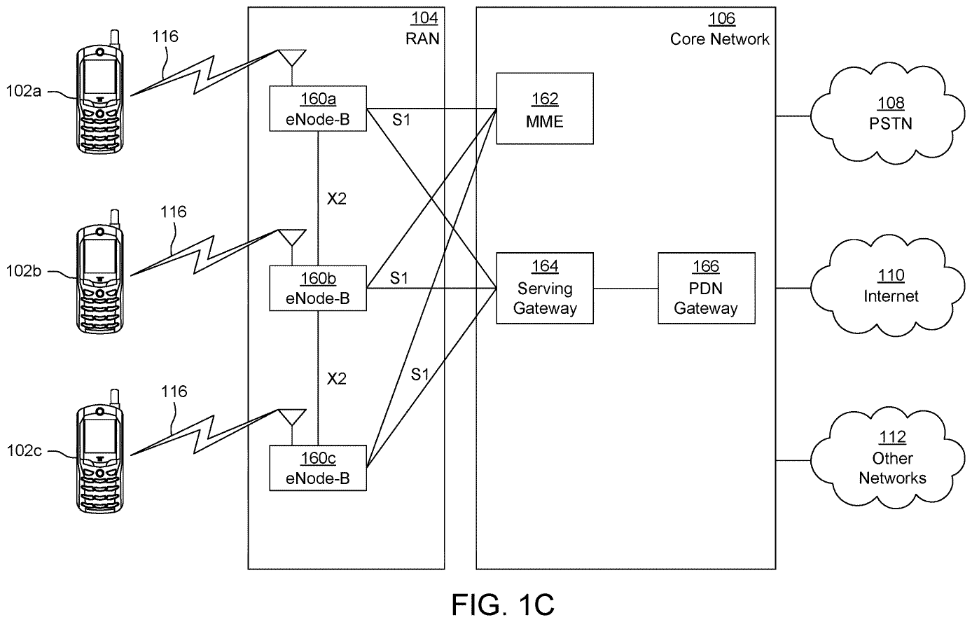

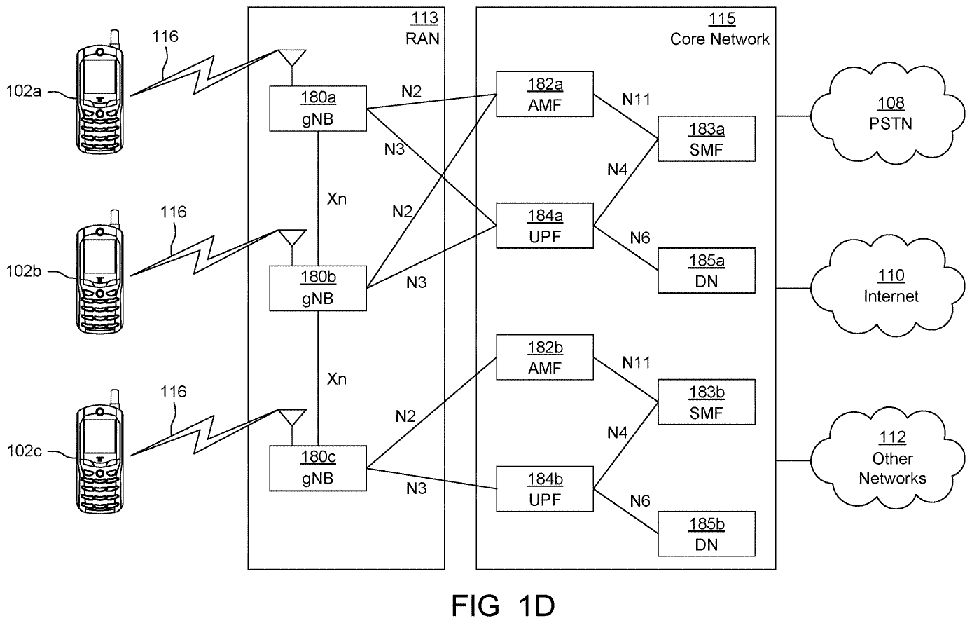

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000(IS- 2000 ), Interim Standard 95(IS-95 ), Interim Standard 856(IS-856 ), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA2000, WiMAX, E-UTRA, or WiFi radio technology.

The CN 106/115 may also serve as a gateway for the WTRUs 102 a, 102 b, 102 c, 102 d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102 a, 102 b, 102 c and IP-enabled devices. The UPF 184, 184 b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Al Deployment in Wireless Networks

When running neural networks (the model) on WTRU devices in a wireless network (e.g., cellular), these neural networks may be delivered to the WTRU from a model repository in the wireless network. The wireless network may aim to deliver a neural network that matches the resources available on the WTRU (the WTRU capabilities) and the application requirements, for example, in terms of level of accuracy. In 3GPP AIML (Artificial Intelligence/Machine Learning) initiative, the network may deliver a model to the WTRU, selecting the model that matches the best the current environment conditions.

When the available WTRU capabilities and/or the application requirements change, the neural model currently used by the WTRU may no longer be the best choice and may even require resources above the current WTRU capabilities. In such a case, a new, more suitable model may be delivered from the model repository by the network.

### Adaptive Neural Networks

Adaptive neural networks are one or several neural networks that can be constructed from a subset of a set of building blocks. For example, several classes of adaptive neural networks correspond to a model that can be described as a sequence of subsets from 1 to n. Any sub-sequence of subsets from 1 to k can be combined to create a functional neural network able to perform a task. Typically, the computational, memory, energy requirements, and/or accuracy of the network increase with k. As another example, adaptive neural networks can also be networks sharing the same initial level of performance. Hence, the end of the neural network can be changed based on the task or multiple ends can reuse the computation from the same initial levels to solve different tasks more efficiently.

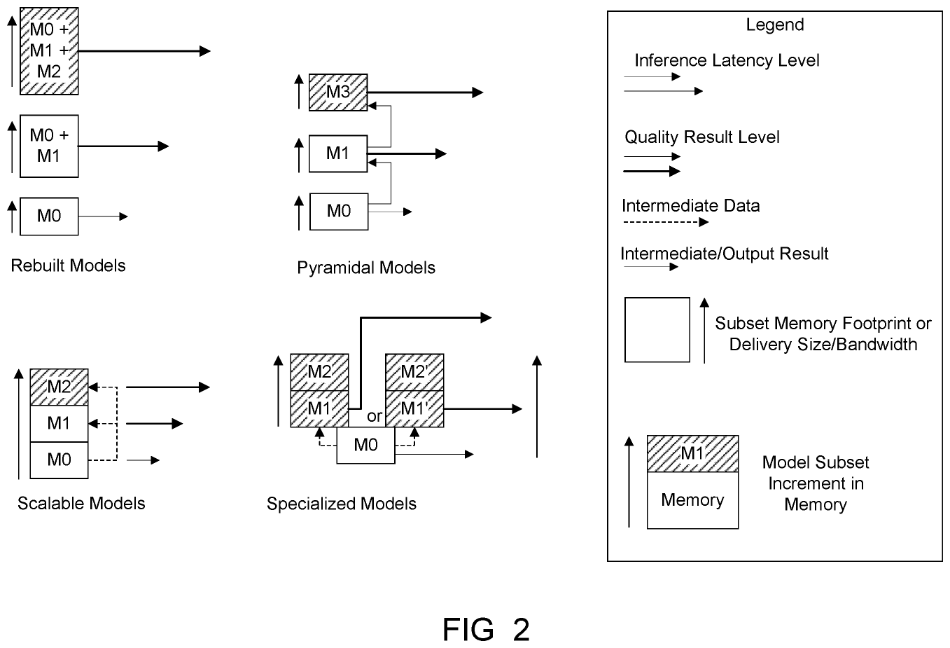

FIG. 2 illustrates different adaptive model compositions and how the adapted performance level N+1 (in hatched) sent to the WTRU runs on top of the existing level N (in green). In FIG. 2, the inference latency level may be proportional to the length of the arrow. The quality of the result may be proportional to the thickness of the arrow. The shape of the arrow indicates whether the output is (1) an intermediate output or result output (in solid line) or (2) intermediate data the only purpose of which is to feed the next level (in dashed line). The length of the vertical arrows indicate the memory footprint (amount of memory). When there are two or more different vertical arrows in a particular model, this means that the process of running Mn, then Mn+Mn+1 are independent.

Referring first to rebuilt models as shown in the upper left portion of FIG. 2, these are Models that need rebuilding at the WTRU when the WTRU receives a new model subset that is not stackable. In this type of update, the update of the model cannot be performed by stacking on additional neural network layers on top of the preexisting layers, but must be rebuilt in its entirety. Unlike slimmable/pruned models (updates add neurons to neural layers, making them larger) or multi-precision quantized models (updates provide additional bits for network weights), in this type of update, when receiving M2 after M0, M1, the new model must be rebuilt in its entirety from the M0, M1, M2 subset.

With regard to multi precision models, the neural network is the same, but with different quantized model parameters N or N+1. Either (1) the quantized model of subset N+1 is recompiled from subset N with different quantization parameters from Subset N+1 or (2) the new quantized parameters replace the whole previous quantized values.

With regard to pruned model, the model network of the subset N+1 contains the model network of the subset N. The pruned model of subset N+1 is recompiled from subset N and additional neurons from subset N+1.

Referring now to scalable models as shown in the lower left portion of FIG. 2, M0, M1, M2 are stackable in the memory, wherein each subset provides an output/intermediate result, e.g., with an increased level of quality. An example of scalable model may be a so-called ‘early exits model’ wherein the network contains exit points before reaching the final output that generate intermediate predictions/results.

Referring now to pyramidal models as shown in the upper right portion of FIG. 2, these are models defined with independent model task, where model M1 takes input from model M0 for purposes of refining the result output of model M0. For example, model M0 may be a neural network that determines whether a detected object in an image is a dog, while neural network model M1 determines the type of the dog (e.g., golden retriever).

Referring now to pyramidal models as shown in the lower right portion of FIG. 2, specialized models M0, M1 or M0, M1′ are stackable in the memory but adapted for different device capabilities (e.g., memory footprint), power consumption, energy, or tasks. A new corresponding subset M2, M2 will be stackable, respectively, on M1, M1′.

In the 3GPP AIML initiative, the wireless network may select the model that matches the best the current environment conditions and delivers it to the WTRU. When the environment changes, an update may be required to meet the new conditions. Updating a brand-new model by downloading and/or loading in memory a new different model can be costly in terms of time, energy, and/or bandwidth, even if the models are compressed. In addition, model updates may require establishing or maintaining a delivery session between the WTRU and the wireless network. An update of a model sometimes may not be achievable depending on the localization of the WTRU and the current network conditions.

Disclosed below are methods and apparatus for a wireless network to provide adaptive models adapted for the WTRU, wherein the adaptive models correspond to a model composed of subsets with an increasing level of model performance (e.g., precision), possibly corresponding to a need for increasing levels of WTRU capability. The WTRU may send to the network adaptive model level requirements that meet different WTRU capabilities. The wireless network may transmit to the WTRU a general Al model description including model composition, adaptive model type, and information for the WTRU to handle the adaptive model.

In a first set of embodiments that are WTRU centric, the WTRU provides a set of different adaptive model requirements, e.g., performance levels (accuracy 80, 90, 95%), different adaptive WTRU capabilities levels (X, Y, Z Flops), and/or composition types (scalable models). The wireless network either starts a learning process targeting the different WTRU requirements or identifies an adaptive model that matches them as best as possible. The network may send back one or several adaptive model compositions to the WTRU.

In some embodiments, the WTRU may select a model and the model level. The WTRU may request to download the whole model composition or request to download subsets of the adaptive part corresponding to its current performance and capability requirements. Upon a change in conditions, the WTRU may select and adjust the right level for inference locally including directly loading and running the other subset level for inference. If necessary, it may request to download of the remaining part of the adaptive model level from the network.

Alternatively, the WTRU may prefer to select an adaptive loading mode wherein it may select a model composition and requests to download the model subset level per level. The network may adapt the recommendation for each model level subset on the fly.

In a second set of embodiments that are network centric, the WTRU may provide to the wireless network its current capabilities that can be allocated to a model. The wireless network may compute and select the adapted model and the recommended level that best matches the corresponding WTRU capabilities and current environment conditions. The wireless network may assist the WTRU by sending recommendations to the WTRU to infer (i.e., execute or run) the whole or a part of an adapted model up to the best level. The WTRU may request and download all or part of the model. When conditions change, the wireless network may send a recommendation to increase or decrease the level. The network may continuously monitor the WTRU capabilities as well as other environment conditions and send recommendations upon detection of a change in such conditions.

### Scalable AI Model Coding Features

A scalable adapted model may comprise a model composition with an increasing range of adaptive coding features levels (levels 1 to n), wherein each an adaptation level may be optimized for a specific set of criteria. A non-exhaustive list of potential criteria may comprise any of criteria described below.

A non-exhaustive list of potential criteria may comprise a performance level, e.g., one or a combination of any of: model accuracy; model precision; model recall; mean square error; and absolute error.

A non-exhaustive list of potential criteria may comprise an adaptive model type, e.g., one or a combination of any of:
Scalable: Subset Level N+1 may run on top of Subset Level N.
Specialized: output of Subset Level N may feed Subset N+1 or another Subset N′+1. Multi precision model: The model graph and its internal composition is invariant but each level N or N+1 has different quantized model parameters, respectively, N or N+1.
Pruned model: The model network of Subset N+1 contains the model network of Subset N.

A non-exhaustive list of potential criteria may comprise a (e.g., required) WTRU capability level, e.g., one or a combination of any of: computing power; memory; energy; and model computing latency.

A non-exhaustive list of potential criteria may comprise a network bandwidth required, for example, a network latency.

WTRU-centric request procedures according to some embodiments may involve one or more messages between the WTRU and the wireless network and operations performed at the WTRU or wireless network, such as any of:

The WTRU may provide information of its different capability levels to the network, such as energy, computing power, memory capacity, and possibly the current capability model to download.

The network may have processed adaptive trained models or may start training adaptive models based on the WTRU requirements, including several ranges of WTRU capabilities.

The network may return to the WTRU the adaptive model composition that best fits the different adaptive level request. The WTRU may trigger the network to train a new adaptive model that meet the different WTRU capability levels. The network may directly initiate the delivery session of the model corresponding to the current WTRU capability.

The WTRU may request to download all or part of the model composition if the network does not initiate the delivery.

The WTRU may select the model subset that corresponds to its resources available or allocated to the AIML application.

When conditions change, the WTRU may select the model part corresponding to the requirements. If the WTRU has not already download the upper subsets or if the model is a monolithic structure, it may first download the model before inference (i.e., before executing the AI model).

The WTRU may process the remaining part of the model dynamically to get the output result.

The WTRU may infer (i.e., execute) the first model subset before requesting a second model subset to the network. The request for the second model subset may depend on the inference results of the first model subset. For example, the WTRU may request a specialized subset or request a new on-the fly subset along with the transmitting of the updated WTRU capabilities or environment conditions.

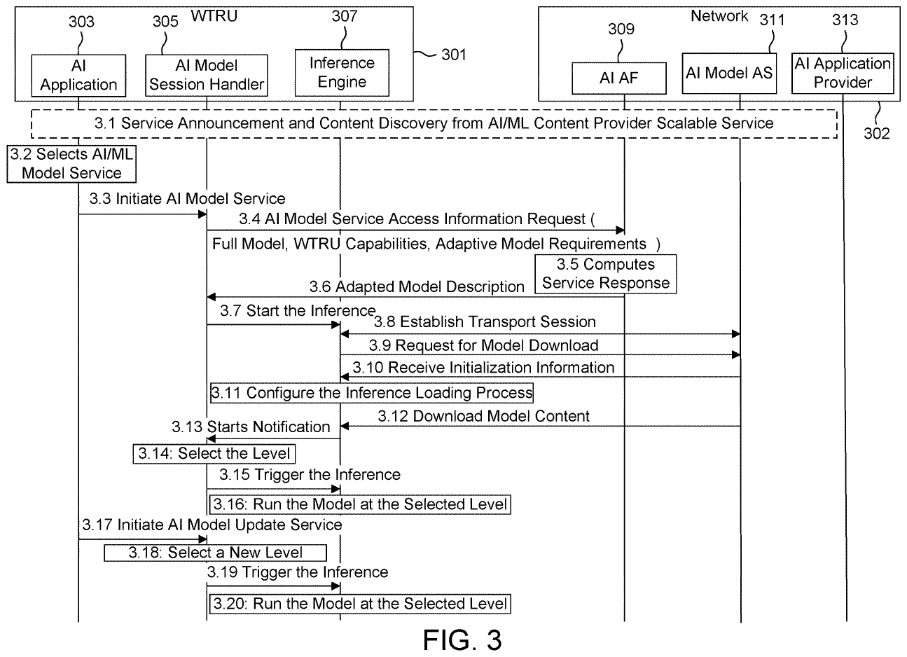

FIG. 3 is a signal flow diagram illustrating signal flow of a WTRU requesting a full model from the wireless network in accordance with a WTRU-centric embodiment.

Step 3.1 represents the initial service announcement and provisioning of an AI/ML service with scalable model compositions.

In step 3.2, the AI application 303 at the WTRU 301 may select an AI Model service.

In step 3.3, the AI Application 303 may trigger the AI Model Session Handler 305 to start. The AI Application 301 may provide application level WTRU capabilities such as the battery status, computing power resources, memory available to the AI Model Session Handler 305. The AI application may provide a set of different adaptive model level requirements, such as different performance levels (e.g., accuracy 80%, 90%, 95%) or different adaptive WTRU capability levels (X, Y, Z Flops) and expected composition types (scalable models).

In step 3.4, the Al Model Session Handler 305 may transmit a model service information request to the wireless network 302, e.g., to an Al Model AS (Application Server) 311. This message may transmit the current WTRU capabilities regarding a model to the network 302. It may request the Full Model.

In step 3.5, the wireless network, e.g., an AI Application Function (AF), may compute the best adapted model for the WTRU's capabilities and conditions.

In step 3.6, the network may provide to the WTRU an adapted model including WTRU capabilities associated with the level of the adapted model. This may comprise information such as any of: a general AI model description, for example an adaptive model type. This may comprise information such as any of: a level description, for example describing one or more requested capabilities and/or one or more results accuracy. For example,
Level 1, Requested capabilities, results accuracy.
Level 2: Requested capabilities, results accuracy.
Level 3: Requested capabilities, results accuracy.

In step 3.7, the AI Model Session Handler 305 may trigger the Inference Engine 307 to start the session for downloading the Model from the network.

In step 3.8, the Inference Engine 307 may establish the transport session with the wireless network.

In step 3.9, the Inference Engine may send a request for the AI model download.

In step 3.10, the network may send the WTRU initialization information.

In step 3.11, the Inference Engine may configure the loading process.

In step 3.12, the Inference Engine may download the Full model from the wireless network.

In step 3.13, the Inference Engine 307 may notify the AI Model Session Handler 305 of the transport session information and AI model content related information.

In step 3.14, the AI model Session Handler 305 may select the model level by comparing WTRU capabilities provided from the AI Application 303 to the level description of the adapted model information received from the network.

In step 3.15, the AI model Session Handler may trigger the Inference Engine for the new model level to infer.

In step 3.16, the Inference Engine 307 may run the model at the selected level.

In step 3.17, the AI Application 303 may trigger the Al Model Session Handler 305 to update. Within this message, the AI Application may provide application level WTRU capabilities such as the battery status, computing power resources, and available memory. The selection module may be part of the AI Model Session Handler 305.

In step 3.18, the AI Model Session Handler 305 may select the new model level.

In step 3.19, the AI Model Session Handler may trigger the inference for the new model level.

In step 3.20, the Inference Engine 307 may run the model at to the selected level.

In another embodiment, the network may propose different model alternatives beyond the recommended one (in step 3.6). In that case, the AI Model Session Handler 305 may trigger the AI application 303 with the set of adaptive models. In turn, the AI Application 303 may send back the selected model to the AI model Session Handler 305. The AI Model Session Handler 305 may select the running level for the model.

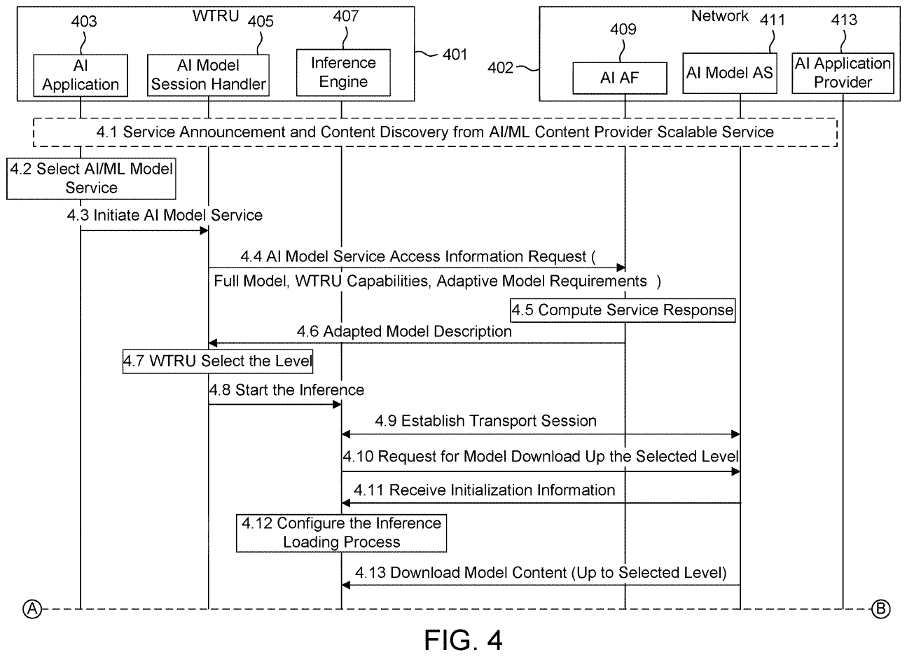

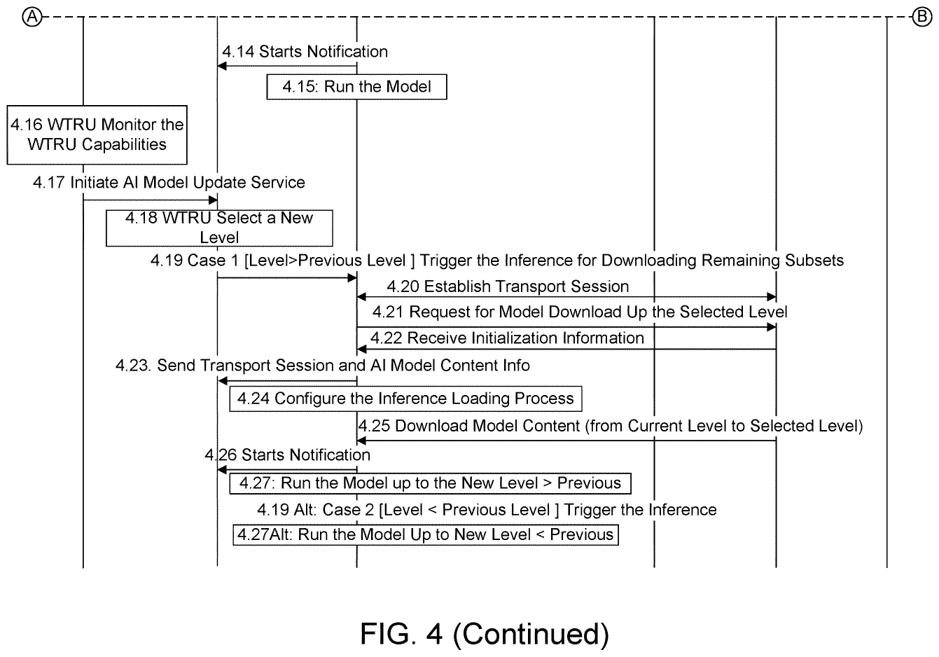

FIG. 4 is a signal flow diagram illustrating signal flow of a WTRU requesting adaptive loading of a model from the wireless network in accordance with a WTRU-centric embodiment.

Steps 4.1 through 4.3 may be essentially the same as steps 3.1 through 3.3 in FIG. 3.

In step 4.3, the AI application 403 may have provided a set of different adaptive model level requirements for the adaptive model, such as different performance levels (accuracy 80%, 90%, 95%) or different adaptive WTRU capabilities levels (X, Y, Z Flops).

In step 4.4, the AI Model Session Handler 405 may transmit a model service information request to the wireless network 402. This message passes the current WTRU capabilities regarding a model to the network 402 and adaptive model level requirements received from the AI application.

In step 4.5, the wireless network, e.g., an AI AF 409, computes the best adapted model for the WTRU capabilities and conditions.

In step 4.6, the network provides to the WTRU the adapted model including WTRU capabilities associated with the level of the adapted model. This may comprise information such as a general AI model description, for example, an adaptive model type. This may comprise information such as a recommended model (optional), for example describing one or more requested capabilities and/or one or more results accuracy. For example, Level 1: Requested capabilities, results accuracy. This may comprise information such as a Level description, for example describing one or more requested capabilities and/or one or more results accuracy. For example,
Level 1, Requested capabilities, results accuracy.
Level 2: Requested capabilities, results accuracy.
Level 3: Requested capabilities, results accuracy.

In step 4.7, the AI model Session Handler 405 may select the model level by comparing WTRU capabilities provided from the AI Application 403 to the level description of the adapted model information received from the network.

In step 4.8, the AI model Session Handler 405 may trigger the Inference Engine to start the session for downloading the recommended Model from the network.

Step 4.9, the Inference Engine 407 may establish the transport session with the wireless network.

In step 4.10, the Inference Engine 407may send the request for the progressive download content.

Step 4.11, the network may send the WTRU initialization information.

In step 4.12, the Inference Engine may configure the loading process.

In step 4.13, the Inference Engine may download the model content up to the selected level.

In step 4.14, The Inference Engine 403 may notify the AI Model Session Handler 405 of the transport session information and AI model content related information.

In step 4.15, the Inference Engine 407 may run the model at the selected level.

In step 4.16, the Al Application 403 continuously monitors the WTRU's conditions.

In step 4.17, the AI Application 403 may trigger the AI Model Session Handler 405 to update. The AI Application may provide application level WTRU capabilities such as the battery status, computing power resources, and available memory in this message. The selection module may be part of the AI Model Session Handler 405.

In step 4.18, the Al Model Session Handler 405 may select the new model level.

In step 4.19, if the model level is greater than the level of the existing running model, the Al Model Session Handler 405 may trigger the Inference Engine 407 to download the remaining subsets up to the selected level.

In step 4.20, the Inference Engine 407 may establish the transport session with the network.

In step 4.21, the Inference Engine 407 may send the request for the progressive download content.

In step 4.22, the network may transmit to the WTRU initialization information.

In step 4.23, the Inference Engine 407 may notify the Al Model Session Handler 405, providing the transport session information and Al model content related information.

In step 4.24, the Inference Engine 407may configure the loading process.

In step 4.25, the Inference Engine may download the model content from the current level to the newly selected level.

In step 4.26, the Inference Engine 407 may notify the Al Model Session Handler 405 of the transport session information and Al model content related information.

In step 4.27, the Inference Engine 407 may run the model up to the selected level.

As shown at the bottom of FIG. 4, if, it is determined that the new model level is lower than the existing running model, in step 4.19, the Al Model Session Handler 405 instead may trigger the Inference Engine 407 for running the inference up to the new, lower selected level, all of steps 4.20-4.26 are omitted (as no download of model information is necessary), and, step 4.27 is replaced with step 4.27Alt, in which the Inference Engine 407 may run the model up to the new lower selected level.

In network-centric embodiments, the WTRU may provide its current capabilities regarding a model to the network and the network may compute and may select the best adapted model for the WTRU's capabilities. The network may indicate to the WTRU which level of the adapted model the WTRU may use depending on environment conditions and WTRU capability monitoring. The network may provide to the WTRU a list of WTRU capabilities corresponding to the level of the adapted model.

The network may provide the whole model to the WTRU if the WTRU has sufficient memory although the WTRU may indicate to the network to send part of the model now if the current conditions do not permit reception of the whole model.

For instance, the network may transmit the model subsets up to a level corresponding to the current WTRU capabilities and then transmit the remaining model subsets of higher levels when the WTRU's capabilities increases.

The WTRU may notify the network when conditions change at the WTRU.

In response, the network may select and indicate to the WTRU at which Model subset (i.e., level) to stop.

If the WTRU does not have the necessary model subsets in memory (typically, this condition would exist when the WTRU reports to the network that its capabilities have increased), the network may transmit the remaining adapted model subset(s) to the WTRU that best fits the new conditions.

The WTRU may run the remaining part of the model to get the output result or may run the model up to the level indicated by the network, e.g., Level 1 instead of Full model.

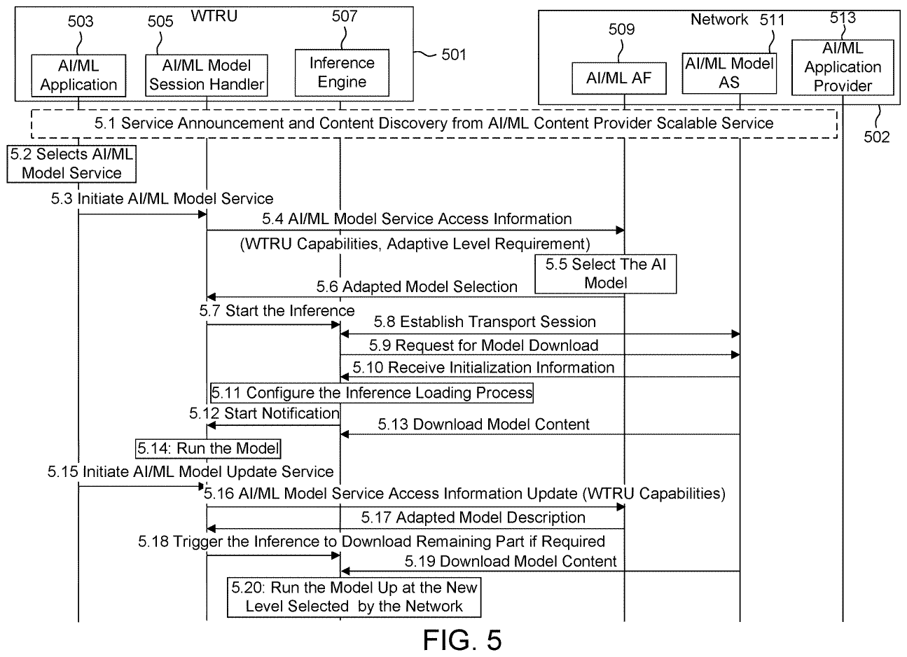

FIG. 5 is a signal flow diagram illustrating signal flow for updating an AI model at a WTRU in accordance with a network-centric embodiment.

Step 5.1 represents the initial service announcement and provisioning of an AI/ML service with scalable model compositions.

In step 5.2, the Al application 503 may select an AI Model service.

In step 5.3, the AI Application 503 may trigger the AI Model Session Handler 505 to start. The AI Application 301 may provide application level WTRU capabilities such as the battery status, computing power resources, memory available. The AI application may provide a set of different adaptive model level requirements, such as minimum performance required, e.g., 80% for a first level, and other expected gradual performance levels (accuracy 85, 90, 95%).

In step 5.4, the AI Model Session Handler 505 may transmit a model service information request to the wireless network 502, e.g., to an AI/ML Model AS 511. This message passes the current WTRU capabilities regarding a model to the network 502.

In step 5.5, the wireless network, e.g., an AI/ML AF 509, may select the best adapted model for corresponding to the WTRU capabilities and conditions.

In step 5.6, the network provides to the WTRU the description of the adapted model including WTRU capabilities associated with the level of the adapted model. This may comprise information such as a general AI model description, for example, an adaptive model type. This may comprise information such as a recommended model, for example describing one or more requested capabilities and/or one or more results accuracy. For example, Level 1: Requested capabilities, results accuracy. This may comprise information such as a level description, for example describing one or more requested capabilities and/or one or more results accuracy. For example,
Level 1, Requested capabilities, results accuracy.
Level 2: Requested capabilities, results accuracy.
Level 3: Requested capabilities, results accuracy.

In step 5.7, the AI Model Session Handler 505 may trigger the Inference Engine 407 to start the session.

In step 5.8, the Inference Engine 507 may establish the transport session with the wireless network.

In step 5.9, the Inference Engine may send a request for the progressive download content.

In step 5.10, the network may send the WTRU initialization information.

In step 5.11, the Inference Engine may configure the loading process.

In step 5.12, The Inference Engine 507 may notify the AI Model Session Handler 505 of the transport session information and Al model content related information.

In step 5.13, the Inference Engine may download the model from the server.

In step 5.14, the Inference Engine may run the model up to the selected level.

In step 5.15, the AI Application 503 may trigger the AI Model Session Handler 505 to update. The AI Application may provide new application level WTRU capabilities such as the battery status, computing power resources, memory available.

In step 5.16, the AI Model Session Handler provides a model service information request to the network. This message passes the current WTRU capabilities regarding a model to the network.

In step 5.17, the network provides to the WTRU the description of the adapted model including WTRU capabilities associated with the level of the adapted model. This may comprise information such as a general AI model description, for example, an adaptive model type. This may comprise information such as a recommended model (optional), for example describing one or more requested capabilities and/or one or more results accuracy. For example, Level 2: Requested capabilities, results accuracy. This may comprise information such as a Level description, for example describing one or more requested capabilities and/or one or more results accuracy. For example,
Level 1, Requested capabilities, results accuracy.
Level 2: Requested capabilities, results accuracy.
Level 3: Requested capabilities, results accuracy.

If the WTRU capabilities increased, the network selects and, if necessary, may transmit the description of the remaining adapted model subset to the WTRU that best fits the new conditions. If the WTRU capabilities decreased, the network indicates to the WTRU at which Model subset to stop.

In step 5.18, if the level of the AI model is increasing, the AI Model Session Handler 505 may trigger the Inference Engine 507 to download the remaining model parts. If the level is decreasing, then step 18 as well as the following step 19 are not necessary.

In step 5.19, the Inference Engine 507 may download the remaining model parts from the server.

In step 5.20, the Inference Engine may run the model up to the selected level.

WTRU subscription with network capabilities monitoring

As an alternative to the previous embodiment, the network may continuously monitor the environment conditions and the WTRU's capabilities.

The WTRU may subscribe to obtain the best adapted model from the network, including increasing or decreasing the level of an already selected AI model.

As a result, the network may notify the WTRU of the best adapted model and the model level when such conditions and/or capabilities change. The network may assist the WTRU and send recommendation to the WTRU to run all or part of an adapted model up to the best level.

If the WTRU does not have all the Al model subsets, the WTRU will download the remaining adapted model parts.

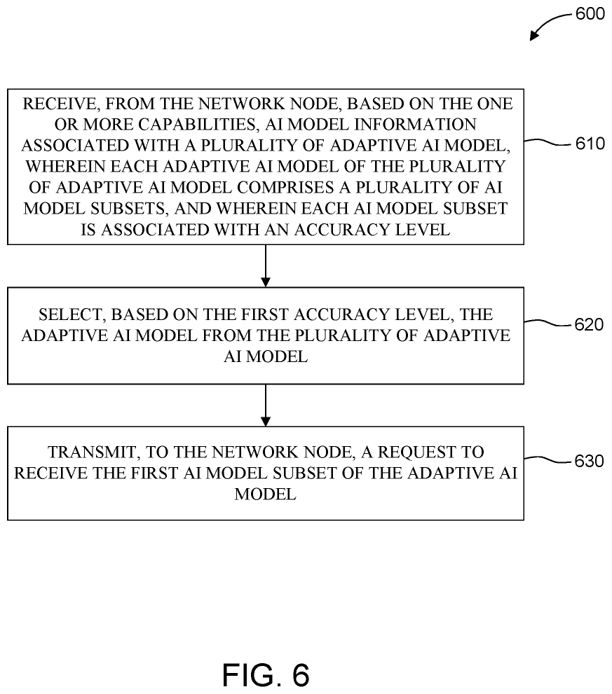

FIG. 6 is a flowchart illustrating a representative method 600 implemented by a WTRU. Referring to FIG. 6, the representative method 600 may include, at block 610, transmitting, to a network node, information indicating one or more capabilities of the WTRU for running an AI model.

At block 620, the representative method 600 may include, receiving, from the network node, based on a comparison of the one or more capabilities of the WTRU and a first accuracy level, a first AI model subset of an adaptive Al model, wherein the adaptive AI model may comprise a plurality of AI model subsets, each subset being associated with an accuracy level.

At block 630, the representative method 600 may include, running the first AI model subset of the adaptive AI model.

In certain representative embodiments, the representative method 600 may include any of the following steps: receiving, from the network node, based on the one or more capabilities, AI model information associated with a plurality of adaptive AI model, wherein each adaptive AI model of the plurality of adaptive AI model comprises of a plurality of AI model subsets, and wherein each AI model subset is associated with an accuracy level; selecting, for example based on the first accuracy level, the adaptive AI model from the plurality of adaptive AI model; and transmitting, to the network node, a request to receive the first Al model subset of the adaptive AI model.

In certain representative embodiments, the one or more capabilities of the WTRU comprise any of: battery status at the WTRU, computing power resources at the WTRU, and available memory at the WTRU.

In certain representative embodiments, the representative method 600 may include any of the following steps: receiving, from the network node, based on a comparison of the one or more capabilities of the WTRU and a second accuracy level, a second AI model subset of the adaptive AI model, wherein the second accuracy model is higher than the first accuracy level; and running the second AI model subset of the adaptive AI model.

In certain representative embodiments, the representative method 600 may include sending a request to receive the second AI model subset, based on a change of the one or more capabilities of the WTRU.

In certain representative embodiments, the representative method 600 may include any of the following steps: determining an increase of the of the one or more capabilities of the WTRU; and running the second AI model subset of the adaptive AI model.

In certain representative embodiments, the representative method 600 may include any of the following steps: determining a decrease of the of the one or more capabilities of the WTRU; and running the first AI model subset of the adaptive Al model.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAS), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.) and/or “permissive” terms (e.g., the term “is” and/or the term “are” may be interpreted as “may” and/or “might”, the terms “refer(s)” may be interpreted as “may refer” and/or “might refer”, the terms “receive(s)” may be interpreted as “may receive” and/or “might receive”, the terms “support(s)” may be interpreted as “may support” and/or “might support”, the terms “interface(s)” may be interpreted as “may interface” and/or “might interface”, the terms “transmit(s)” may be interpreted as “may interface” and/or “might interface”, “may transmit” and/or “might transmit”, the terms “send(s)” may be interpreted as “may send” and/or “might send”, the terms “does not refer” (and/or the like) may be interpreted as “may not refer” and/or “might not refer”, the terms “does not receive” (and/or the like) may be interpreted as “may not receive” and/or “might not receive”, the terms “does not support” (and/or the like) may be interpreted as “may not support” and/or “might not support”, the terms “does not interface” (and/or the like) may be interpreted as “may not interface” and/or “might not interface”, the terms “does not transmit” (and/or the like) may be interpreted as “may not transmit” and/or “might not transmit”, the terms “does not send” (and/or the like) may be interpreted as “may not send” and/or “might not send”, etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method implemented in a wireless transmit/receive unit, WTRU, the method comprising:
transmitting, to a network node, information indicating one or more capabilities of the WTRU for running an AI model;
receiving, from the network node, information respectively associated with a plurality of subsets of an adaptive part of the AI model, wherein each subset is associated with an accuracy level;
selecting, based on the one or more capabilities of the WTRU, a first subset from the plurality of subsets, the first subset having a first results accuracy level;
transmitting, to the network node, a first request to receive the first subset;
receiving, from the network node, the first subset
running the first subset;
sending, to the network node, based on an increase of the one or more capabilities of the WTRU, a second request to receive a second subset having a second results accuracy model that is higher than the first results accuracy level;
receiving, from the network node, the second subset; and
running the second subset to obtain a result.

2. (canceled)

3. The method of claim 1, wherein the one or more capabilities of the WTRU comprise any of: battery status at the WTRU, computing power resources at the WTRU, and available memory at the WTRU.

4-7. (canceled)

8. A wireless transmit/receive unit, (WTRU,) comprising circuitry, including a transmitter, a receiver, a processor and memory, the WTRU configured to:
transmit, to a network node, information indicating one or more capabilities of the WTRU for running an AI model;
receive, from the network node, information respectively associated with a plurality of subsets of an adaptive part of the AI model, wherein each subset is associated with an accuracy level;
select, based on the one or more capabilities of the WTRU, a first subset from the plurality of subsets, the first subset having a first results accuracy level;
transmit, to the network node, a first request to receive the first subset;
receive, from the network node, the first subset
run the first subset;
send, to the network node, based on an increase of the one or more capabilities of the WTRU. a second request to receive a second subset having a second results accuracy model that is higher than the first results accuracy level;
receive, from the network node, the second subset; and
run the second subset to obtain a result.

9. (canceled)

10. The WTRU of claim 8, wherein the one or more capabilities of the WTRU comprise any of: battery status at the WTRU, computing power resources at the WTRU, and available memory at the WTRU.

11-14. (canceled)
